(19) United States
(12) Patent Application Publication
(10) Pub. No.: US 2006/0056638 A1
(43) Pub. Date: Mar. 16, 2006

(54) Sound reproduction system, program and data carrier

(75) Inventor: Daniel Willem Elisabeth Schobben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/528,491

(22) PCT Filed: Sep. 16, 2003
(86) PCT No.: PCT/IB03/04098

§ 371 Date: Mar. 18, 2005

(30) Foreign Application Priority Data
Sep. 23, 2002 (EP) 02078943.4
Oct. 15, 2002 (EP) 02079297.4

(51) Int. Cl. H04R 5/00; H04R 5/02

(52) U.S. Cl. 381/17; 381/309

(57) ABSTRACT

The sound reproduction system comprises a sound production means (101), e.g. a headphone loudspeaker, and an audio processor (105) capable of applying a first head related transfer function (130) to an input audio signal (106) from an audio signal source (110) and capable of delivering an output audio signal (108) to the sound production means (101). The audio processor (105) is arranged to apply the first head related transfer function (200) over a first frequency range and a second head related transfer function (202, 204) over a second frequency range. The second head related transfer function (202, 204) may be modeled by calculating means (152) or selected from a memory (150).

The invention relates to a sound reproduction system comprising:

a sound production means;

an audio processor with a filter arranged for applying a first head related transfer function (HRTF) to an input audio signal from an audio signal source, and yielding an output audio signal for the sound production means; and

a first data source, which is arranged for delivering first filter coefficients of the first head related transfer function to the filter.

The invention also relates to a computer program for execution by a processor, describing a method of sound reproduction comprising the steps:

obtaining coefficients of a first head related transfer function filter from a first data source;

applying a first head related transfer function filtering to an input audio signal from an audio signal source, yielding an output audio signal.

The invention also relates to a data carrier storing a computer program for execution by a processor, describing a method of sound reproduction comprising the steps:

obtaining coefficients of a first head related transfer function filter from a first data source;

applying a first head related transfer function filtering to an input audio signal from an audio signal source, yielding an output audio signal.

The invention also relates to a data carrier storing a first head related transfer function over a first predetermined frequency range.

The invention also relates to a signal transmission system transmitting a first head related transfer function over a first predetermined frequency range.

Such a sound reproduction system is known from WO-A-0149066. The preferred embodiment of the known system consists of a pair of headphones, arranged to simulate any sound source around a user of the headphones, which is called a headphone virtualizer. The headphones can simulate e.g. loudspeakers required for Dolby digital 5.1—i.e. a left, a center and a right loudspeaker, at least one left surround and one right surround speaker, and if required a speaker for the low frequency effects—hence they obviate the need of using all these loudspeakers. Furthermore, a true three-dimensional sound field can be simulated as e.g. in the ambiophonics approach. Also any room acoustics can be simulated.

To present to the user's ear the same sound from a closeby headphone loudspeaker as would be presented by a faraway loudspeaker driven by an input audio signal, the input audio signal has to be filtered by a head related transfer function, yielding an output audio signal to be inputted to the headphone loudspeaker. The HRTF characterizes the transmission of the sound from the faraway loudspeaker to an ear, after e.g. reflecting on walls, interacting with the torso and pinna of the user, etc. Generally, virtualizers use a standard head related transfer function, e.g. for an average human. The drawback of this approach is that the user has learned to localize a sound with his own particular body and pinna shape, and hence with an incorrect HRTF sounds are perceived as coming from inside the head, or the front and back directions are confused. The known system avoids this drawback by incorporating microphones in the headphones measuring the sound from a faraway loudspeaker as it enters the ear. On the basis of these measurements, a HRTF for the particular user is obtained.

It is a disadvantage of the known system that the measured HRTF has inaccurate values for some frequency regions, leading to inaccurate positioning of a virtual sound source.

It is a first object of the invention to provide a sound reproduction system of the kind described in the opening paragraph, which is relatively accurate.

It is a second object to provide a computer program according to the invention as described in the opening paragraph.

It is a third object of the invention to provide a data carrier storing a computer program according to the invention.

It is a fourth object of the invention to provide a data carrier storing two complementary HRTFs.

It is a fifth object of the invention to provide a signal transmission system transmitting two complementary HRTFs.

The first object is realized in that a second data source is present, which is able to deliver second filter coefficients of a second head related transfer function to the filter for filtering the input audio signal yielding the output audio signal. The filter can apply the first HRTF over a first frequency range where the coefficients of the first HRTF are accurate, and apply the second HRTF over a second frequency range, e.g. the frequency range where the coefficients of the first HRTF are inaccurate. The coefficients of the second HRTF can then be determined with a more reliable method, e.g. a measurement in a dedicated laboratory.

An additional advantage of using two or more HRTFs is that desirable effects can be implemented more easily, such as e.g. changing the acoustics of a virtual room. Adding a virtual carpet to the room e.g. can be modeled by changing a HRTF in a frequency range of higher frequencies, for which the carpet is highly absorbing.

The first, second and if required further frequency ranges can also be predetermined overlapping instead of disjunct, e.g. in an application which selects a frequency range for easy postprocessing.

It is advantageous if a microphone is present for performing a sound measurement and the first data source comprises coefficient calculation means for calculating the first filter coefficients from the sound measurement, and the second data source comprises a memory for storing data related to the second head related transfer function. The memory can then contain e.g. the coefficients of a standard HRTF for the higher frequencies, which was measured in a laboratory.

Additionally, it is also advantageous if the second data source comprises calculating means for calculating coefficients of the second head related transfer function filter based on data from the memory. The calculating means can then e.g. derive a parametric HRTF for the higher frequencies, e.g. based on measurements of the geometrical or audio characteristics of the ear of the user. Required parameters and formulae can be stored in the memory.

The second and third objects are realized in that the method of the computer program according to the invention, stored on the data carrier according to the invention, comprises further steps of

obtaining coefficients of a second head related transfer function from a second data source; and

applying a second head related transfer function filtering to an input audio signal from an audio signal source, yielding an output audio signal.

The fourth and fifth objects are realized in that

also a second head related transfer function over a second predetermined frequency range (F2) is stored respectively transmitted, and

the second head related transfer function comprises complementary information, improving the simulation of sound from a loudspeaker by means of sound production means.

These and other aspects of the sound reproduction system, the computer program and the data carrier according to the invention will be apparent from and elucidated with reference to the implementations and embodiments described hereinafter, and with reference to the accompanying drawings, which serve merely as non limiting illustrations.

In the drawings:

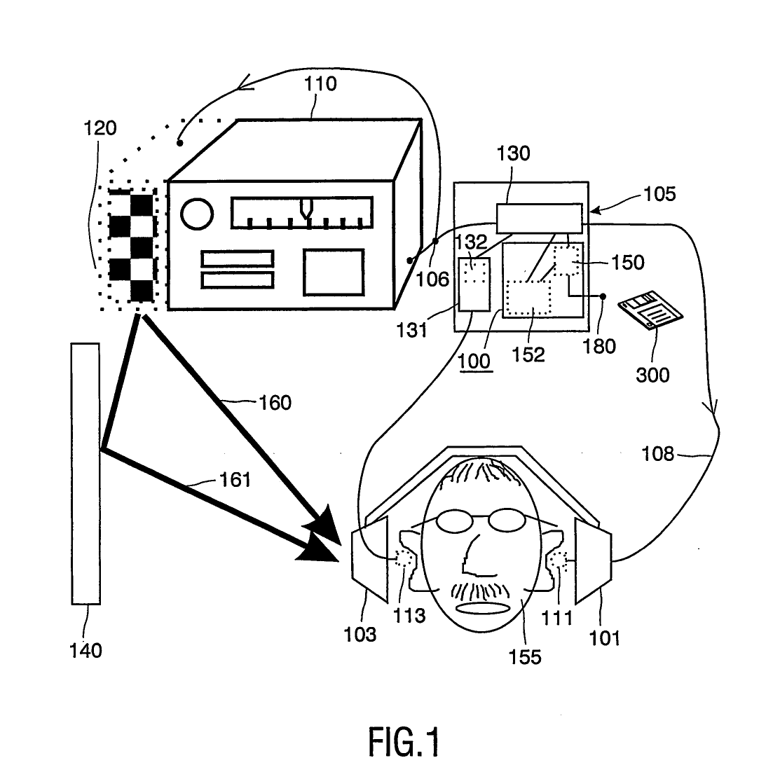

FIG. 1 schematically shows a sound reproduction system according to the invention;

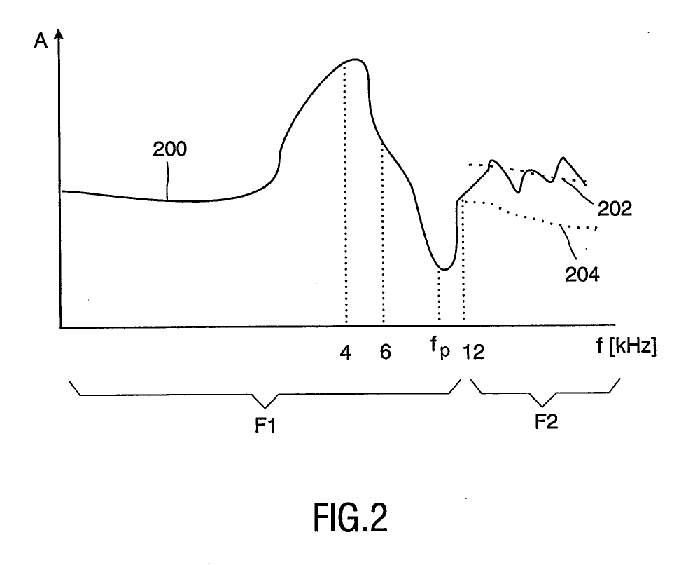

FIG. 2 schematically shows a head related transfer function (HRTF); and

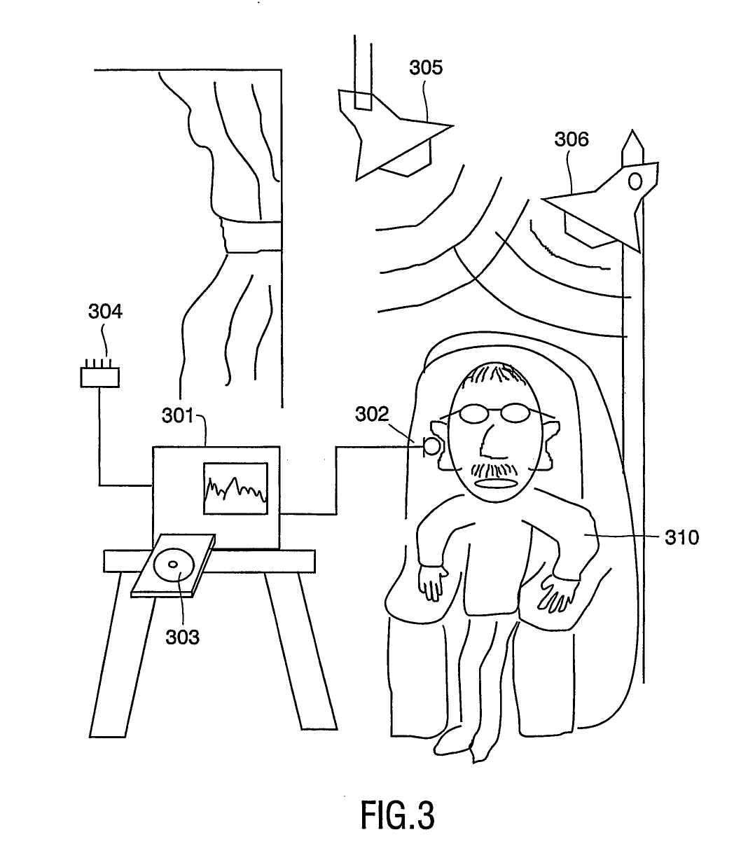

FIG. 3 shows a HRTF measurement facility.

In these Figures elements drawn dashed are optional, depending on the desired embodiment.

FIG. 1 shows an audio signal source 110, e.g. a radio or a DVD-player, which sends an input audio signal 106 to a loudspeaker 120 for sound reproduction. Also shown is a pair of headphones, comprising headphone loudspeakers 101 and 103 to produce substantially the same sound from the input audio signal 106 at an ear of a user 155 as the loudspeaker 120. To achieve this an audio processor 105 is present, which comprises a filter 130 for filtering input signal 106 yielding output signal 108 for the headphone loudspeakers 101 and 103. Additionally, a first data source 131 is present for delivering first filter coefficients of a first head related transfer function 200—shown in FIG. 2—to the filter 130, and a second data source 100 is present for delivering second filter coefficients of a second head related transfer function, e.g. 202, to the filter 130. The second data source 100 may comprise a memory 150. In this memory 150 a number of HRTFs can be stored, e.g. as measured in a laboratory for a number of test persons. Memory 150 can also store parameters and formulae required by calculating means 152 for modeling a HRTF. Vice versa coefficients resulting from modeling by calculating means 152 can be stored in memory 150 for later use, instead of being sent to filter 130 directly. A data loading means 180 may be present for loading data in the memory, e.g. by attaching a drive for a data carrier 300, or a connection to the internet. The data may also be preloaded in memory 150 in the factory. User 155 can e.g. select one of the HRTFs stored in memory 150, for which the values in the frequency range higher than 12 kHz are most desirable, e.g. because they yield optimal sound localization.

Loudspeaker 120 has to be interpreted as a predetermined sound source depending on the application, such as:

a left surround loudspeaker in a home cinema application;

a sound generated by a virtual character of a computer game or virtual reality application in a certain position in a virtual space; or

a sound from a particular direction associated to one of a multitude of communication channels in a speech communication application, such as applied in a command center.

The sound travels to the ear of a user 155 via a direct path 160, but also via indirect paths, such as reflecting path 161, which reflects from an object 140. Objects can also absorb and scatter sound, and sound can also be transmitted, e.g. by a window. The sound also interacts with various body parts of the user 155, before it finally enters his ear. This process results in that the relative power at a particular sound frequency as measured by the ear is increased or decreased compared to the power emitted by loudspeaker 120, which can be modeled by a filter function. This filter function is called a head related transfer function (HRTF), which is user-dependent, room-dependent, dependent on the direction of a sound source like loudspeaker 120, and dependent on the position of user 155 and loudspeaker 120 in the room. It is possible to simulate the sound produced by loudspeaker 120 as perceived by the ear of user 155, by applying substantially the same sound field to the ear by means of a headphone loudspeaker 103, or in general another loudspeaker in the room. The input audio signal 106 can not be applied directly to the headphone loudspeaker 103, for then the user 155 would perceive the sound as coming from the position of the headphone loudspeaker 103, instead of as coming from the position of loudspeaker 120. In order to achieve a convincing simulation of loudspeaker 120, the input audio signal has to filtered by an audio processor 105, in which filter 130 applies a first HRTF, which is substantially the true HRTF 200 for the particular user 155, position, and so on. In general headphone virtualizers use a fixed HRTF, or an HRTF selected from a number of stored HRTFs measured in advance for different people. If the HRTF used is not the one corresponding to the particular user 155, accurate sound location in general does not occur. E.g. a sound source in the back can be erroneously heard in front, the elevation of the sound will be misjudged, or the sound might be perceived as originating inside the head. To obtain the true HRTF 200, a left microphone 113 is present for measuring sound e.g. as it enters the ear of user 155, and similarly to obtain the HRTF from loudspeaker 120 to the other ear, a right microphone 111 is present. WO-A-0149066 describes an algorithm for obtaining the HRTFs from measurements by microphones 111 and 113. A loudspeaker positioned in an environment of user 155, like loudspeaker 120, is used to generate sound to be measured by microphones 111 and 113. After the measurement one can dispose of loudspeaker 120, since the resulting measurement data can be stored in memory, and used for obtaining HRTF coefficients when necessary. Coefficient calculation means 132 applies an algorithm for obtaining HTRF coefficients from microphone measurements.

There are a number of applications which benefit from the use of a second HRTF.

Firstly, the true HRTF 200 can not be obtained accurately from the microphone measurements for all frequencies. E.g., for high frequencies, e.g. over 9 kHz, the position of the microphones 111 and 113 is very critical, and hence the obtained values of the HRTF for high frequencies are inaccurate, which could again result in bad localization of simulated sound sources. In a consumer application it is desirable that the microphone does not enter the ear canal, which results in reduced accuracy of the HRTF coefficients for high frequencies. Furthermore if the HRTF measurement is performed by means of noise cancellation, obtaining accurate HRTF coefficients for high frequencies implies that the user should sit very still. For low frequencies, there is often environmental noise present, however the algorithms for obtaining the HRTF have no way of deciding whether this noise originated from the loudspeaker 120. This can lead to inaccurate HRTF values in the low frequency region, e.g. below 200 Hz. More reliable HRTF values for a predetermined second frequency range F2 can be obtained from a different source than in situ microphone measurement for obtaining the HRTF in an unequal predetermined first frequency range F1, e.g. from a dedicated laboratory measurement. These more reliable values are used in the second HRTF.

Secondly, in case a user 155 wants to change a certain part of a HRTF, e.g. to make a virtual room that he simulates sound more like an opera house or outdoors instead of a room he is present in, it is desirable to realize this with as few operations as possible, and without any additional microphone measurements. This is facilitated by applying several HRTFs.

Thirdly the choice of possible HRTF filter structures is diversified. Typically a finite impulse response (FIR) filter is used for realizing the HRTF. However for the low frequencies, sound keeps reflecting off the walls for a long time, necessitating a FIR filter with many coefficients. It is advantageous to realize the filtering of the lower frequencies with an Infinite Impulse Response (IIR) filter. This is e.g. realized when the filter 130 is realized as a first HRTF filter which filters the higher frequencies and leaves the low frequencies unchanged, and second HRTF filter which is realized as an IIR filter, filtering only the low frequencies. The filters can be disjunct means, or can be realized sequentially on a processor.

FIG. 2 schematically shows a true HRTF 200—solid line—as it can be measured for a particular user 155, for a loudspeaker 120 e.g. straight in front of the user 155, and at a certain elevation. An amplitude A of an audio signal as measured by the microphone 113 positioned e.g. near the entrance of an ear is shown for different frequencies f. The effect of environmental objects, such as the ear pinna, on sound traveling from loudspeaker 120 to the position of the microphone 113 is then characterized. This effect is different when the loudspeaker producing the sound is e.g. headphone loudspeaker 103, which is closer to the microphone 113, and of which the sound does not interact with e.g. a wall in the environment of user 155. The low frequency behavior is determined amongst others by the room and the torso of the user 155. At around 4 kHz there is a peak due to positive interference in the ear canal. Somewhere around a notch frequency fₚ—e.g. between 6 and 12 kHz-, there is a destructive interference due to reflections on the pinna, called the “pinna notch”. In the schematic true HRTF 200, in a second frequency range F2 higher then e.g. 12 kHz, the microphone measurement is inaccurate. A simple embodiment of the sound reproduction system according to the invention specifies e.g. the first HRTF to be the true HRTF 200 in a first frequency range F1 upto 12 kHz, and uses e.g. a modeled HRTF 202—dashed line—as the second HRTF for the frequencies in a second frequency range F2 over 12 kHz. In this second frequency range F2 the sound modification can be modeled e.g. by a head shadow model, as e.g.

$$ITD = \frac{r}{c} [ θ + sin θ ] , \text{and}$$

$$IID = 1 + sin θ {f}^{0.8} ,$$

in which ITD is an interaural time difference, r the radius of the head of user 155 or an average user, c the speed of sound, θ an azimuthal direction of a sound source, IID an interaural intensity difference, and f a frequency. If the first HRTF is substantially the true HRTF 200 over a sufficiently large frequency range, and the second HRTF comprises reasonably correct coefficients, good sound localization occurs. Other models can be applied, e.g. a Kahunen-Loeve expansion from simpler HRTFs or HRTFs measured e.g. in a laboratory. Outer ear and ear canal geometrical or sound filtering parameters can be used to obtain a desired HRTF model, the parameters being obtained e.g. from measurements by microphones 111 and 113 of sound emitted by headphone loudspeakers 101 and 103. Another embodiment comprises modelization of the pinna notch. The notch frequency fₚ shifts with the elevation of a sound source. In a gaming application e.g., a flying sound source can be simulated as follows. In this embodiment, the first HRTF is e.g. equal to the true HRTF 200 over the entire frequency range, except that between 6 and 12 kHz no filtering occurs. The second HRTF applies a notch with a notch frequency fₚ dependent on the height of the flying sound source in a frequency range e.g. between 6 and 12 kHz. Head tracking means might also be present to obtain head position parameters for obtaining modeled HRTF 202. Another example of a functionality that can be realized with the sound reproduction system is on the fly simulation of room changes. E.g. putting a virtual carpet on the floor, which increases absorption of higher frequencies, can be modeled by replacing modeled HRTF 202 by room feature modeling HRTF 204—dotted line. Calculating means 152 perform the necessary modeling calculations to obtain the correct values for the first and/or the second HRTF. Care should be taken that the amplitude level of the first and the second HRTF are tuned to each other, and in case of switching to a different second HRTF, artifacts like audible clicks should be avoided by applying a transition strategy.

It should be clear that the proposed implementations of the HRTFs can be realized in the time domain as well as in the frequency domain. Instead of applying the sound field corresponding to a virtual source in the environment to the ears of user 155 by means of headphone speakers 101 and 103, speakers positioned in the room like loudspeaker 120 can be used, as is described in WO-A-0149066. The audio processor 105 or any of its constituents can be realized as a separate entity, or can form part of the audio signal source 110 or the headphones.

FIG. 3 shows a facility for HRTF measurement. Such a professional facility can be present e.g. in a dedicated music shop. In stead of a cheap microphone 111 incorporated in headphones, a more professional microphone 302 may be present, which e.g. measures deeper in the ear canal of user 310. Furthermore, professional loudspeakers 305, 306 may be present, as well as professional acoustic wall covering. Audio processing apparatus 301, may perform further calculations on the data received from the professional microphone 302, such as e.g. simulating extra room reverberations to model a concert hall. These calculations can be performed directly on the professional microphone 302 signal or on the HRTF obtained therefrom. Data for the second HRTF can e.g. be downloaded from a database on the Internet to which only the shopkeeper has access, via a signal transmission system 304. The two HRTFs are then e.g. stored on data carrier 303, which can be e.g. an optical disk or flash memory in an MP3 player of user 310. Alternatively, the HRTFs can be transmitted over signal transmission system 304, e.g. the Internet or a wireless connection to e.g. a portable device. The second frequency range F2 is so chosen that the second head related transfer function 202, 204 comprises information complementary to that of the first head related transfer function 200, so that when both HRTFs are used together by filter 130, the simulation of sound from a loudspeaker 120 by means of sound production means 101 is improved, as far as e.g. sound localization is concerned, compared to when using either HRTF on its own. Both HRTFs can be combined to a single HRTF before storage or transmission. Another possibility is that a number of additional HRTFs are stored over the second frequency interval, e.g. a number of pinna notch HRTFs to quickly simulate the vertical position of a sound source.

It should be noted that the above-mentioned embodiments illustrate rather than limit the invention and that those skilled in the art are able to design alternatives, without departing from the scope of the claims. Apart from combinations of elements of the invention as combined in the claims, other combinations of the elements within the scope of the invention as perceived by one skilled in the art are covered by the invention. Any combination of elements can be realized in a single dedicated element. Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

The invention can be implemented by means of hardware or by means of software running on a computer, and previously stored on a data carrier or transmitted over a signal transmission system.

1. A sound reproduction system comprising:
an audio processor with a filter arranged for applying a first head related transfer function over a predetermined first frequency range to an input audio signal from an audio signal source, and yielding an output audio signal for a sound production means; and
a first data source, which is arranged for delivering first filter coefficients of the first head related transfer function to the filter,
characterized in that
a second data source is comprised, which is arranged for delivering second filter coefficients of a second head related transfer function over a predetermined second frequency range, unequal to the first frequency range, to the filter for filtering the input audio signal yielding the output audio signal.

2. A sound reproduction system as claimed in claim 1, characterized in that
a microphone is included for performing a sound measurement; and
the first data source comprises coefficient calculation means for calculating the first filter coefficients from the sound measurement; and
the second data source comprises a memory for storing data related to the second head related transfer function filter.

3. A sound reproduction system as claimed in claim 2, characterized in that
the second data source comprises calculating means for calculating the second filter coefficients based on data from the memory.

4. A computer program for execution by a processor, describing a method of sound reproduction comprising the steps:
obtaining coefficients of a first head related transfer function from a first data source;
applying a first head related transfer function filtering to an input audio signal from an audio signal source, yielding an output audio signal,
characterized in that the computer program comprises further steps in its method of:
obtaining coefficients of a second head related transfer function from a second data source; and
applying a second head related transfer function filtering to an input audio signal from an audio signal source, yielding an output audio signal.

5. A data carrier storing a computer program for execution by a processor, describing a method of sound reproduction comprising the steps:
obtaining coefficients of a first head related transfer function from a first data source;
applying a first head related transfer function filtering to an input audio signal from an audio signal source, yielding an output audio signal,
characterized in that the data carrier stores further steps of the method:
obtaining coefficients of a second head related transfer function from a second data source; and
applying a second head related transfer function filtering to an input audio signal from an audio signal source, yielding an output audio signal.

6. A data carrier storing a first head related transfer function over a first predetermined frequency range, characterized in that
also a second head related transfer function over a second predetermined frequency range is stored, and
the second head related transfer function comprises complementary information, improving the simulation of sound from a loudspeaker by means of sound production means.

7. Signal transmission system transmitting a first head related transfer function over a first predetermined frequency range, characterized in that
also a second head related transfer function over a second predetermined frequency range is transmitted, and
the second head related transfer function comprises complementary information, improving the simulation of sound from a loudspeaker by means of sound production means.
